(19) United States
(12) Patent Application Publication
(10) Pub. No.: US 2014/0072043 A1
(43) Pub. Date: Mar. 13, 2014

(54) VIDEO DEBLOCKING FILTER STRENGTH DERIVATION

(71) Applicant: APPLE INC., Cupertino, CA (US)

(72) Inventors: Alexandros Tourapis, Milpitas, CA (US); Athanasios Leontaris, Mountain View, CA (US)

(73) Assignee: Apple Inc., Cupertino, CA (US)

(21) Appl. No.: 13/759,851

(22) Filed: Feb. 5, 2013

Related U.S. Application Data
(60) Provisional application No. 61/699,218, filed on Sep. 10, 2012.

(51) Int. Cl. H04N 7/26

(52) U.S. Cl. CPC H04N 19/00721
USPC 375/240.15

(57) ABSTRACT

Codecs may be modified to consider weighting and/or illumination compensation parameters when determining a deblocking filter strength that is to be applied. These parameters may be useful for recording illumination changes, such as fades, cross-fades, flashes, or light source changes, which allows these illumination changes to displayed during playback using the same reference frame data which different weighting and/or illumination compensation parameters applied. In different instances, the parameters may be considered when setting a deblocking filter strength to ensure that these effects are properly displaying during playback while minimizing the appearance of blocking artifacts.

### CROSS-REFERENCE TO RELATED APPLICATIONS

The present application claims the benefit of U.S. Provisional application Ser. No. 61/699,218 filed Sep. 10, 2012, entitled “VIDEO DEBLOCKING.” The aforementioned application is incorporated herein by reference in its entirety.

### BACKGROUND

Existing video coding standards and technologies, such as MPEG-4 AVC/H.264, VC1, VP8, and the HEVC/H.265 video-coding standard, have employed block-based methods for coding information. These methods have included intra and inter prediction, as well as transform, quantization, and entropy coding processes. Intra and inter prediction exploit spatio-temporal correlation to compress video data. The transform and quantization processes, on the other hand, have been used to correct errors that may have incurred due to inaccuracies in prediction, given a constraint in bit rate or target quality. The bit rate or target quality has been primarily controlled by adjusting the quantization level for each block. Entropy encoding has further compressed the resulting data given its characteristics.

Although the above processes have resulted in substantial compression of an image or of video data, the inherent block characteristics of the prediction and coding process have resulted in coding artifacts that could be unpleasant and may result in deteriorating the performance of the coding process. Existing techniques introduced in some codecs and standards have attempted to reduce such coding artifacts. Some of these existing techniques applied a “deblocking” filter after reconstructing an image.

Deblocking filters have analyzed a variety of information about a region or block that has been coded and applied filtering strategies to reduce any detected coding artifacts. In codecs such as MPEG-4 AVC, VC1, VP8, and HEVC, the information may include the type of coding mode used for prediction, such as intra or inter, the motion vectors and their differences between adjacent blocks, the presence or absence of residual data, and the characteristics and differences between the samples that are to be filtered. The process is further controlled by adjusting the filtering process given the quantization parameters that were used for the samples currently being filtered. These characteristics were selected in an effort to maximize the detection ability of possible coding artifacts, also referred to as blocking artifacts.

Some codecs included an illumination compensation process, such as weighted prediction, as part of the inter-prediction process to further improve prediction performance. Motion compensated samples were adjusted through a weighting and offsetting process, which is commonly of the form of the below equation (1), instead of being copied directly from another area as the prediction signal:

y=w·x(mv)+o (1)

In this equation, y is the final motion compensated signal, x is the motion compensated signal given a motion vector mv, w is the weighting (scaling) parameter, and o is the offset. Illumination compensation has reduced blocking artifacts in different instances and not just during illumination changes, such as fades, cross-fades, flashes, light source changes, and so on. The codecs also enabled the prediction of similar samples within the same image using bi-prediction, or different samples within the same image using multiple instances of the same reference with different illumination compensation/weighted prediction parameters.

Unfortunately, these existing codecs have not considered differences in illumination compensation parameters during the de-blocking process. For example, in some instances where two adjacent blocks use the same reference but have different illumination compensation parameters, no de-blocking was performed. This caused blocking artifacts to appear across two neighboring blocks from the same reference even though the illumination compensation parameters are different. The blocking artifacts appeared because existing codecs, such as AVC and HEVC, only examine if the actual references used for prediction are the same, and do not consider whether any additional transformation beyond motion compensation has been applied to the reference samples.

FIG. 1 shows an exemplary process 100 of how existing codecs have determined a deblocking filter strength. In box 101, a block boundary between two pixel blocks p and q may be identified. In box 102, a determination may be made as to whether any of the samples of blocks p or q are intra-coded. In box 103, if at least one of the samples is intra-coded, a determination may be made as to whether the identified boundary in block 101 is a macroblock boundary. If the boundary is a macroblock boundary, then in box 104, the block filter strength may be set to a maximum value, such as 4 in this example.

If the boundary is not a macroblock boundary, then the block filter strength may be set to a non-zero value so that deblocking will be performed. For example, the lesser value 3 in box 105 or the lesser value 2 in box 107 may be used in one example, though other values may be used in other embodiments. If none of the samples is intra-coded, then in box 106, a determination may be made as to whether there are any non-zero transform coefficients such as discrete cosine transform (DCT) or discrete sine transform (DST) coefficients in either block p or block q. If there are any non-zero DCT coefficients in either block p or block q, then the block filter strength may be set to a lesser value, such as value 2 in box 107.

If there are not any non-zero DCT coefficients in either block p or bock q, then in box 108 a determination may be made as to whether blocks p and q have different reference pictures or different numbers of reference pictures. If blocks p and q have different reference pictures or different numbers of reference pictures, then the block filter strength may be set to a lesser value, such as value 1 in box 109.

If blocks p and q do not have different reference pictures or different numbers of reference pictures, then in box 110, a determination may be made as to whether a difference between the motion vectors of blocks p and q in either the horizontal direction or the vertical direction is greater than or equal to a threshold. In the example shown in FIG. 1, the threshold is 4, but in other embodiments different thresholds may be used.

If the difference between the motion vectors of blocks p and q in either the horizontal direction or the vertical direction is greater than or equal to the threshold, then the block filter strength may be set to a lesser value, such as value 1 in box 109, which may be the same lesser value that is set when the blocks p and q have different reference pictures or different numbers of references pictures.

If the difference between the motion vectors of blocks p and q in either direction is less than the threshold, then filtering may be skipped and the block filter strength may be set to a zero or least value, such as value 0 in box 111.

As shown in FIG. 1, block filtering may be skipped when two blocks p and q have similar reference pictures and the motion vector difference between the blocks is less than a threshold value even if additional transformations have been applied to one or more reference samples to generate distinct image blocks p and q from one or more similar reference samples. Thus, blocking artifacts may still be present in the outputted images in these instances when filtering is skipped.

There is a need to eliminate blocking artifacts in those instances where additional transformations have been applied to one or more reference samples to generate distinct image blocks from one or more similar reference samples.

### BRIEF DESCRIPTION OF THE DRAWINGS

FIG. 1 shows a prior art process of how existing codecs have determined a deblocking filter strength.

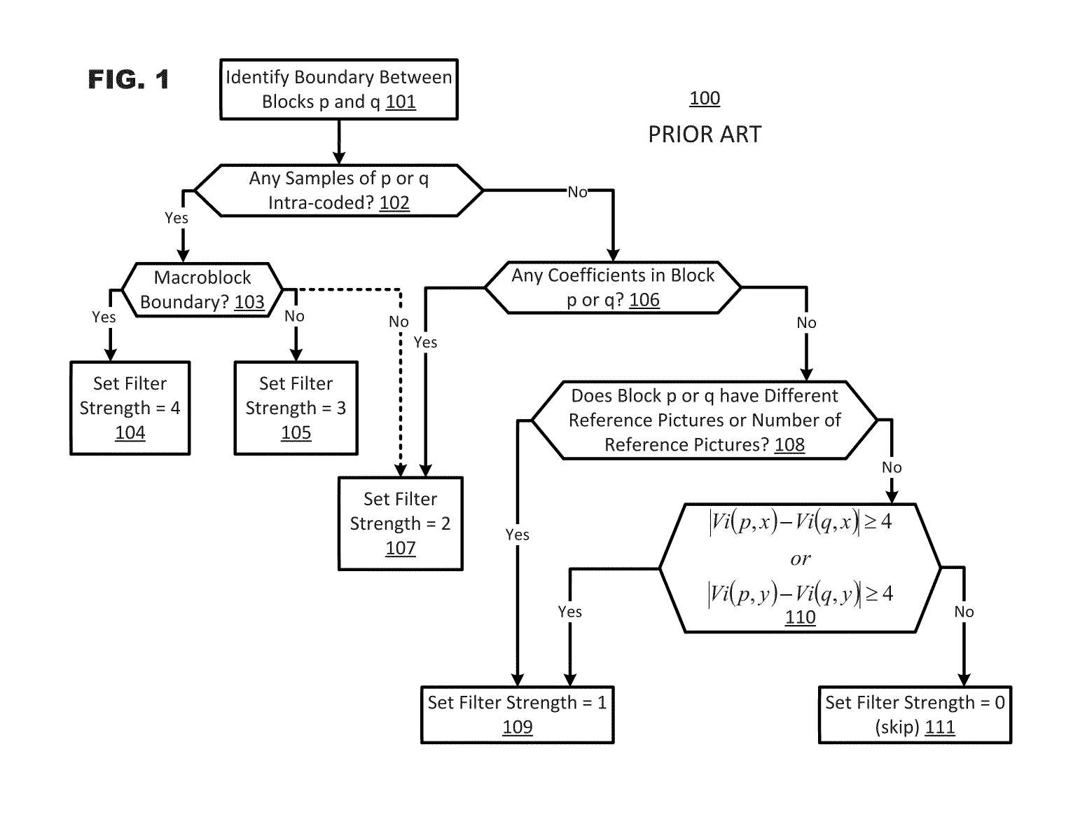

FIG. 2 shows a first exemplary process in an embodiment of the invention.

FIG. 3 shows a second exemplary process in an embodiment of the invention.

FIG. 4 shows a third exemplary process in an embodiment of the invention.

FIG. 5 shows a simplified block diagram of a coding system 500 in an embodiment of the invention that includes components for encoding and decoding video data.

### DETAILED DESCRIPTION

In various embodiments of the invention, one or more codecs may be modified to consider weighting or illumination compensation parameters when determining a deblocking filter strength that is to be applied. For example, instead of just determining whether two blocks p and q use different reference pictures or a different number of reference pictures, in an embodiment a determination may be made as to whether the two blocks p and q have different parameters that were not previously considered, such as weighting prediction parameters.

Codecs may be modified to consider weighting parameters when determining a deblocking filter strength that is to be applied. Weighting parameters may improve the compression efficiency of codecs by better compensating for different effects, such as fades, cross-fades, flashes, or light source changes. Codecs, such as MPEG-2 that do not support weighting parameters may still be able to encode these effects, however the encoding may require substantially more bits to achieve a similar quality. If less bits are used, more coding artifacts may result resulting in poorer perceived quality. In different instances, the weighting parameters may be considered when setting a deblocking filter strength to ensure that these effects are efficiently compressed while minimizing the appearance of blocking artifacts.

Since different weighted prediction parameter values may result in different values in a reference index associated with different image data blocks, in some embodiments, the reference indices of different blocks may be compared when setting the filter strength to determine whether blocks have different weighted prediction parameters. Checking whether the reference indices associated with each block are different instead of checking whether the same reference pictures are used may also simplify the deblocking process as there would be no need to provide an additional mapping from the reference index to the actual reference pointer when checking whether the same reference pictures are used.

In some of these embodiments, a weighted prediction parameter of a video codec inter-prediction process from a reference index in a plurality of blocks may be compared using a processing device. When the compared weighted prediction parameter in the blocks is different, a deblocking filter strength of the blocks may be set to a first value. When the weighted prediction parameter in the blocks is similar, a difference between motion vectors of the respective blocks in a horizontal direction and a vertical direction may be calculated.

When the calculated difference in at least one of the directions is greater than or equal to a threshold, the deblocking filter strength of the blocks may be set to a second value. Otherwise, when the difference in both directions is less than the threshold, the deblocking filter strength of the blocks may be set to a third value.

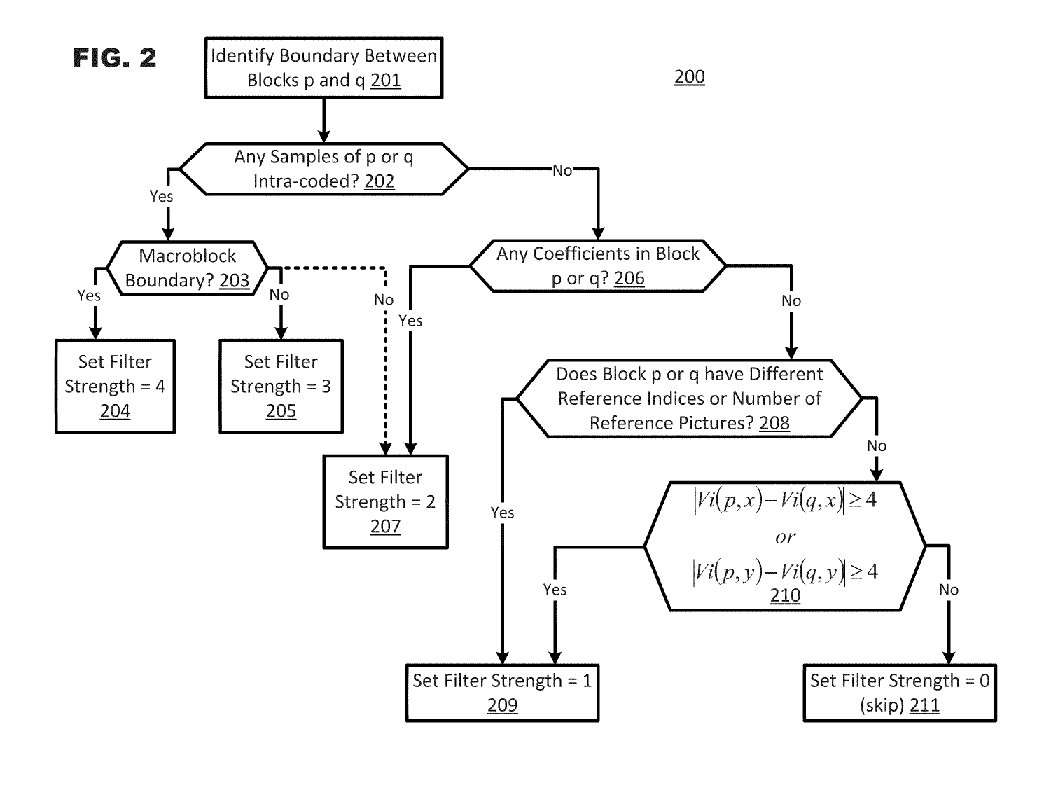

FIG. 2 shows a first exemplary process in an embodiment of the invention. In box 201, a block boundary between two pixel blocks p and q may be identified. In box 202, a determination may be made as to whether any of the samples of blocks p or q are intra-coded. In box 203, if at least one of the samples is intra-coded, a determination may be made as to whether the identified boundary in block 201 is a macroblock boundary. If the boundary is a macroblock boundary, then in box 204, the block filter strength may be set to a maximum value, such as 4 in this example.

If the boundary is not a macroblock boundary, then the block filter strength may be set to lesser value, such as the lesser value 3 in box 205 or the lesser value 2 in box 207 in this example, though other values may be used in other embodiments. If none of the samples is intra-coded, then in box 206, a determination may be made as to whether there are any non-zero discrete cosine transform (DCT) coefficients in either block p or block q. If there are any non-zero DCT coefficients in either block p or block q, then the block filter strength may be set to an even lesser value, such as value 2 in box 207.

If there are not any non-zero DCT coefficients in either block p or bock q, then in box 208 a determination may be made as to whether blocks p and q have different reference indices or different numbers of reference pictures. If blocks p and q have different reference indices or different numbers of reference pictures, then the block filter strength may be set to a lesser value, such as value 1 in box 209.

If blocks p and q do not have different reference indices or different numbers of reference pictures, then in box 210, a determination may be made as to whether a difference between the horizontal or vertical motion vectors of blocks p and q is greater than or equal to a threshold. In the example shown in FIG. 2, the threshold is 4, but in other embodiments different thresholds may be used.

If the difference between the motion vectors of blocks p and q in either direction is greater than or equal to the threshold, then the block filter strength may be set to a lesser value, such as value 1 in box 209, which may be the same lesser value that is set when the blocks p and q have different reference pictures or different numbers of references pictures.

If the difference between the motion vectors of blocks p and q in either direction is less than the threshold, then filtering may be skipped and the block filter strength may be set to a zero or least value, such as value 0 in box 211.

In other embodiments, a determination may be made as to whether the two adjacent blocks p and q use different illumination parameters. These illumination parameters may include the weighting factor w and the offset o in equation (1) above. If either the weighting or the offset parameters is different between the two blocks p and q, then the block filter strength may be set to a higher value than if the weighting and offset parameters are similar. This may ensure that filtering is not skipped when either the weighting or the offset parameters are different between the blocks even though the same reference pictures may be used by both blocks p and q.

In some of these embodiments, an illumination compensation parameter of a video codec inter-prediction process in a plurality of blocks of image data may be compared using a processing device. When the illumination compensation parameter is similar in the plurality of blocks, a deblocking filter strength may be set to a first value. When the illumination compensation parameter is different in the plurality of blocks, the deblocking filter strength may be set to a second value.

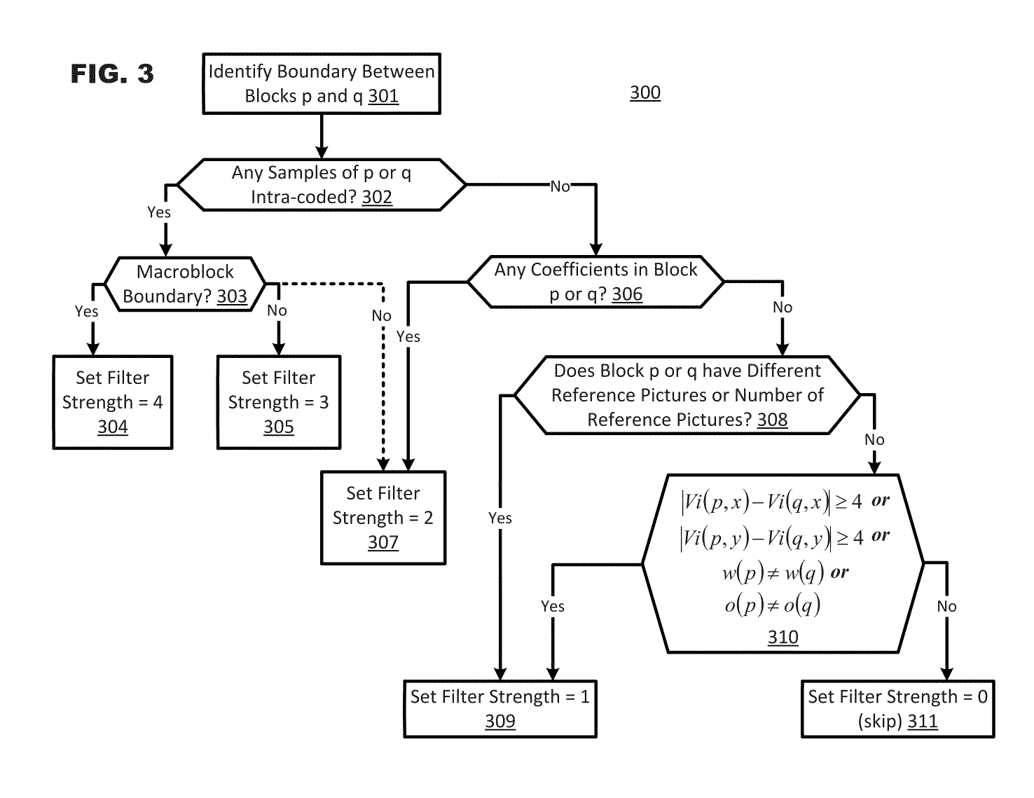

FIG. 3 shows a second exemplary process in an embodiment of the invention. In box 301, a block boundary between two pixel blocks p and q may be identified. In box 302, a determination may be made as to whether any of the samples of blocks p or q are intra-coded. In box 303, if at least one of the samples is intra-coded, a determination may be made as to whether the identified boundary in block 301 is a macroblock boundary. If the boundary is a macroblock boundary, then in box 304, the block filter strength may be set to a maximum value, such as 4 in this example.

If the boundary is not a macroblock boundary, then the block filter strength may be set to lesser value, such as the lesser value 3 in box 305 or the lesser value 2 in box 307 in this example, though other values may be used in other embodiments. If none of the samples is intra-coded, then in box 306, a determination may be made as to whether there are any non-zero discrete cosine transform (DCT) coefficients in either block p or block q. If there are any non-zero DCT coefficients in either block p or block q, then the block filter strength may be set to an even lesser value, such as value 2 in box 307.

If there are not any non-zero DCT coefficients in either block p or bock q, then in box 308 a determination may be made as to whether blocks p and q have different reference pictures or different numbers of reference pictures. If blocks p and q have different reference pictures or different numbers of reference pictures, then the block filter strength may be set to a lesser value, such as value 1 in box 309.

If blocks p and q do not have different reference pictures or different numbers of reference pictures, then in box 310, a determination may be made as to whether (i) a difference between the horizontal or vertical motion vectors of blocks p and q is greater than or equal to a threshold or (ii) either the weighting or the offset parameter is different between the two blocks p and q. In the example shown in FIG. 3, the threshold is 4, but in other embodiments different thresholds may be used.

If the difference between the motion vectors of blocks p and q in either direction is greater than or equal to the threshold, then the block filter strength may be set to a lesser value, such as value 1 in box 309, which may be the same lesser value that is set when the blocks p and q have different reference pictures or different numbers of references pictures. The block filter strength may also be set to the lesser value, such as value 1 in box 309, if either the weighting or the offset parameter is different between the two blocks p and q.

If the difference between the motion vectors of blocks p and q in either direction is less than the threshold, and both the weighting and the offset parameters are similar between the two blocks p and q, then filtering may be skipped and/or the block filter strength may be set to a zero or least value, such as value 0 in box 311.

In another embodiment, the deblocking filter strength may be set to a first value when both of the following conditions occur: (i) at least one of the weighting parameter and the offset parameter is different between the two blocks p and q, and (ii) a difference between at least one of the horizontal or vertical motion vectors of blocks p and q is greater than or equal to a threshold. If only one of the conditions occurs, then the deblocking filter strength may be set to a second value lower than the first value. If none of the conditions occur, then the deblocking filter strength may be set to a third value which may be a lowest value that skips filtering altogether.

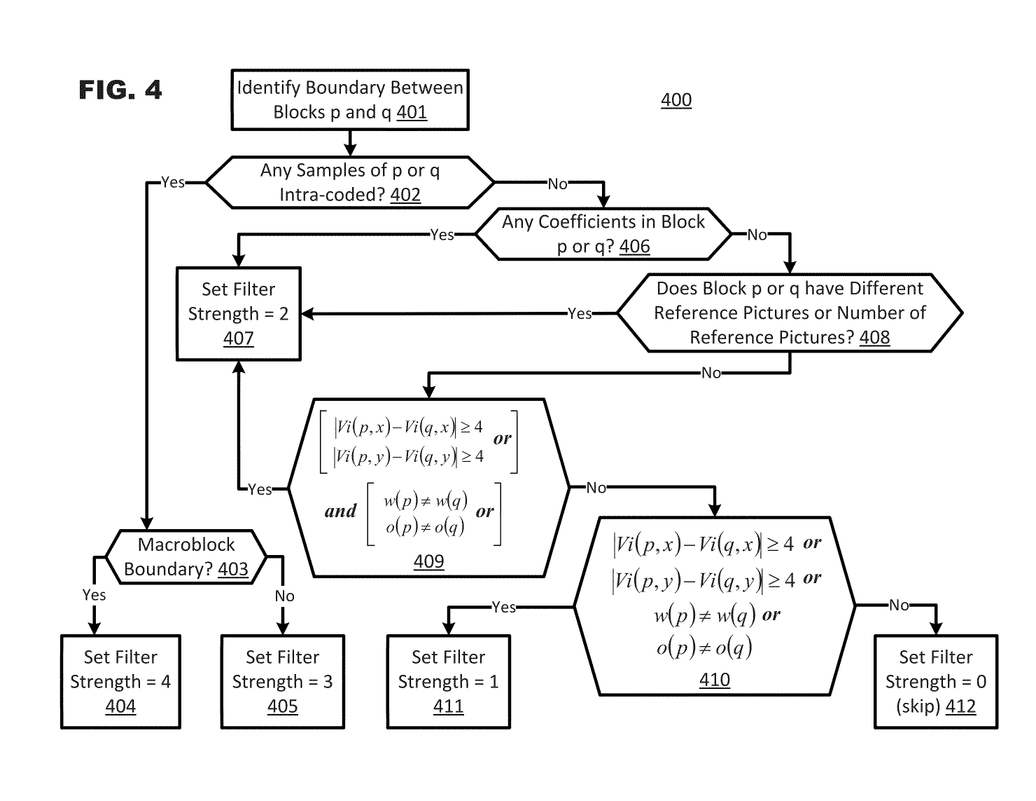

FIG. 4 shows a third exemplary process in an embodiment of the invention. In box 401, a block boundary between two pixel blocks p and q may be identified. In box 402, a determination may be made as to whether any of the samples of blocks p or q are intra-coded. In box 403, if at least one of the samples is intra-coded, a determination may be made as to whether the identified boundary in block 401 is a macroblock boundary. If the boundary is a macroblock boundary, then in box 404, the block filter strength may be set to a maximum value, such as 4 in this example.

If the boundary is not a macroblock boundary, then the block filter strength may be set to lesser value, such as the lesser value 3 in box 405, though this and the other values specified herein may be different in other embodiments. If none of the samples is intra-coded, then in box 406, a determination may be made as to whether there are any non-zero transform coefficients in either block p or block q. If there are any non-zero coefficients in either block p or block q, then the block filter strength may be set to an even lesser value, such as value 2 in box 407.

If there are not any non-zero coefficients in either block p or bock q, then in box 408 a determination may be made as to whether blocks p and q have different reference pictures or different numbers of reference pictures. If blocks p and q have different reference pictures or different numbers of reference pictures, then the block filter strength may be set to one of the existing lesser values, such as value 2 in box 407, or another lesser value.

If blocks p and q do not have different reference pictures or different numbers of reference pictures, then in box 409, a determination may be made as to whether both of the following conditions are satisfied: (i) a difference between at least one of the horizontal or vertical motion vectors of blocks p and q is greater than or equal to a threshold, and (ii) at least one of the weighting parameter and the offset parameter is different between the two blocks p and q. If both of these conditions apply, then the block filter strength may be set to one of the existing lesser values, such as value 2 in box 407, or another lesser value. In the example shown in FIG. 4, the threshold is 4, but in other embodiments different thresholds may be used.

If both of the above conditions are not satisfied, then in box 410, a determination may be made as to whether only one of the conditions is satisfied. If either: (i) a difference between at least one of the horizontal or vertical motion vectors of blocks p and q is greater than or equal to a threshold, or (ii) at least one of the weighting parameter and the offset parameter is different between the two blocks p and q, then the block filter strength may be set to a lesser value than in the prior case when both of the conditions were satisfied. For example, the block filter strength may be set to the value 1 in box 411, or another lesser value. In the example shown in FIG. 4, the threshold is 4, but in other embodiments different thresholds may be used.

If none of the conditions in box 410 are satisfied, then filtering may be skipped and/or the block filter strength may be set to a zero or least value, such as value 0 in box 412.

In other embodiments, additional multiple tiers, similar to blocks 409 and/or 410 could also be used. For example, if the motion vector difference in a dimension is greater than or equal to Xm and the weighting and offset parameters are different then filtering strength Sm may be set. However, if the motion vector difference in a dimension is less than Xm but greater than or equal to Xn, then filtering strength Sn<Sm may be set. Similarly, if the motion vector difference in a dimension is less than Xn but greater than or equal to Xr, then filtering strength Sr<Sn may be set, and so on. In some embodiments, multiple tiers may also be implemented with different motion vector absolute difference thresholds and filtering strength values, even for non-weighted and/or non-offset samples.

The deblocking strength may also be increased given particular quantization parameters of the blocks that are to be filtered. In some instances, the quantization parameters may be used during the setting or applying of the filtering threshold values, but not during the determination of the filtering strength. In some instances, an average, weighted average, or a maximum of the quantization parameter values of the blocks involved may be determined and then used in conjunction with a table lookup processes to derive or otherwise identify a particular threshold value that is to be used.

In some instances, higher quantization parameters may be associated with a higher probability of blocking artifacts appearing in an output, especially in those instances with zero or a few residual coefficients. For example, if a quantization parameter exceeds a value X and there are no coefficients in the blocks to be filtered, then, if motion difference across the two blocks is significant, i.e. above a certain threshold, filtering may be performed at a predetermined filtering strength, such as filter strength value 2. More significant filtering could also be performed if there are discrete cosine coefficients in the blocks with higher quantization parameters. For example, instead of using filtering strength value 2 for such blocks, as is currently done in codecs like AVC or HEVC, a higher filter strength, such as filter strength value 3 may be used.

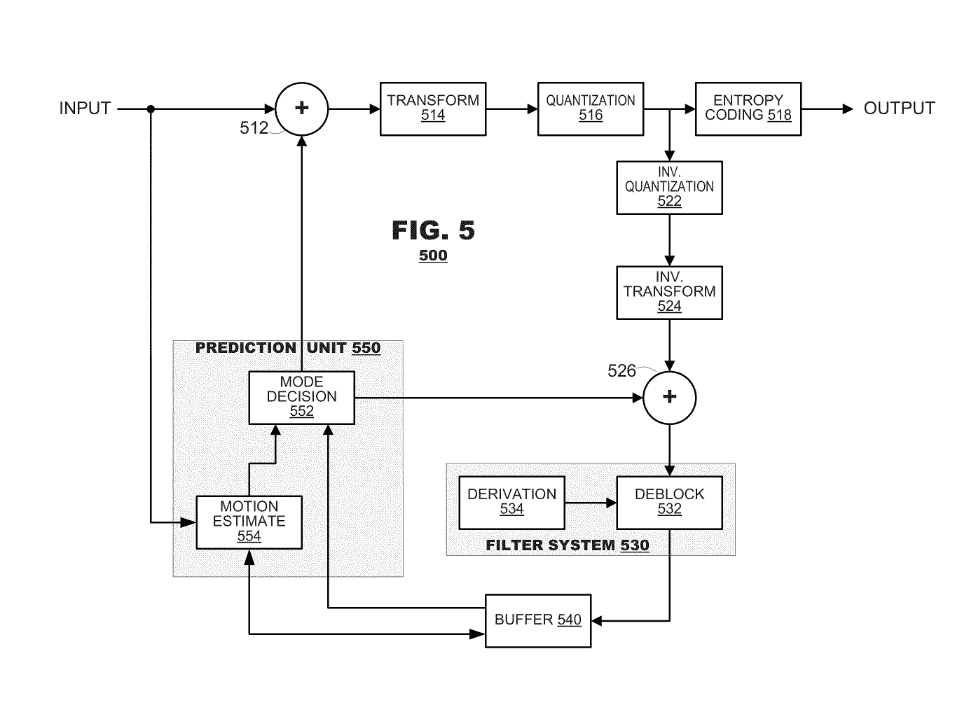

FIG. 5 shows a simplified block diagram of a coding system 500 in an embodiment of the invention that includes components for encoding and decoding video data. The system 500 may include a subtractor 512, a transform unit 514, a quantizer 516 and an entropy coding unit 518. The subtractor 512 may receive an input motion compensation block from a source image and a predicted motion compensation block from a prediction unit 550. The subtractor 512 may subtract the predicted block from the input block and generate a block of pixel residuals. The transform unit 514 may convert the residual block data to an array of transform coefficients according to a spatial transform, typically a discrete cosine transform (“DCT”) or a wavelet transform. The quantizer 516 may truncate transform coefficients of each block according to a quantization parameter (“QP”). The QP values used for truncation may be transmitted to a decoder in a channel. The entropy coding unit 518 may code the quantized coefficients according to an entropy coding algorithm, for example, a variable length coding algorithm. Additional metadata containing the message, flag, and/or other information discussed above may be added to or included in the coded data, which may be outputted by the system 500.

The system 500 also may include an inverse quantization unit 522, an inverse transform unit 524, an adder 526, a filter system 530 a buffer 540, a motion and a prediction unit 550. The inverse quantization unit 522 may quantize coded video data according to the QP used by the quantizer 516. The inverse transform unit 524 may transform re-quantized coefficients to the pixel domain. The adder 526 may add pixel residuals output from the inverse transform unit 524 with predicted motion data from the prediction unit 550. The summed output from the adder 526 may output to the filtering system 530.

The filtering system 530 may include a deblocking filter 532 and a strength derivation unit 534. The deblocking filter 532 may apply deblocking filtering to recovered video data output from the adder 526 at a strength provided by the strength derivation unit 534. The strength derivation unit 534 may derive a strength value using any of the techniques described above. The filtering system 530 also may include other filters that may apply SAO filtering or other types of filters but these are not illustrated in FIG. 5 merely to simplify presentation of the present embodiments of the invention.

The buffer 540 may store recovered frame data as outputted by the filtering system 530. The recovered frame data may be stored for use as reference frames during coding of later-received blocks.

The prediction unit 550 may include a mode decision unit 552, and a motion estimator 534. The motion estimator 534 may estimate image motion between a source image being coded and reference frame(s) stored in the buffer 540. The mode decision unit 552 may assign a prediction mode to code the input block and select a block from the buffer 540 to serve as a prediction reference for the input block. For example, it may select a prediction mode to be used (for example, uni-predictive P-coding or bi-predictive B-coding), and generate motion vectors for use in such predictive coding. In this regard, the motion compensated predictor 548 may retrieve buffered block data of selected reference frames from the buffer 540.

Existing and upcoming video coding standards seem to currently be restricted in terms of the inter prediction modes that are performed. That is, for single list prediction, motion compensation given a reference is performed using a motion vector, a defined interpolation process, and a set of illumination parameters. For bi-prediction, two references may be utilized with different motion vectors and illumination compensation parameters for each. However, future codecs may utilize additional transformation processes such as affine or parabolic motion compensation, de-noising or de-ringing filters, among others. Such mechanisms could be different for each reference, whereas for one reference, similar to the case of weighted prediction, multiple such parameters may also be used for each instance of that reference. In that case, we propose that de-blocking should also account for such differences, when deriving the de-blocking strength, further avoiding and reducing discontinuities across block boundaries.

The foregoing discussion has described operation of the embodiments of the present invention in the context of codecs. Commonly, codecs are provided as electronic devices. They can be embodied in integrated circuits, such as application specific integrated circuits, field programmable gate arrays and/or digital signal processors. Alternatively, they can be embodied in computer programs that execute on personal computers, notebook computers or computer servers. Similarly, decoders can be embodied in integrated circuits, such as application specific integrated circuits, field programmable gate arrays and/or digital signal processors, or they can be embodied in computer programs that execute on personal computers, notebook computers or computer servers. Decoders commonly are packaged in consumer electronics devices, such as gaming systems, DVD players, portable media players and the like and they also can be packaged in consumer software applications such as video games, browser-based media players and the like. And, of course, these components may be provided as hybrid systems that distribute functionality across dedicated hardware components and programmed general purpose processors as desired.

We claim:

1. A method for configuring a deblocking filter to reduce banding artifacts comprising:
comparing a weighted prediction parameter of a video codec inter-prediction process from a reference index in a plurality of blocks using a processing device;
when the compared weighted prediction parameter in the blocks is different, setting a deblocking filter strength of the blocks to a first value;
when the weighted prediction parameter in the blocks is similar:
calculating a difference between motion vectors of the respective blocks in a horizontal direction and a vertical direction;
when the difference in at least one of the directions is greater than or equal to a threshold, setting the deblocking filter strength of the blocks to a second value; and
when the difference in both directions is less than the threshold, setting the deblocking filter strength of the blocks to a third value.

2. The method of claim 1, wherein the first value and the second value are equal and greater than the third value, the first value and the second value indicating filtering should be applied to the block, and the third value indicating that filtering should be skipped for the blocks.

3. The method of claim 2, further comprising, when at least one of the blocks has at least one non-zero transform coefficient, setting the deblocking filter strength to a fourth value higher than the first and the second values to apply stronger filtering to the blocks.

4. The method of claim 3, further comprising, when at least one sample of the blocks is intra-coded, setting the deblocking filter strength to a value at least equal to the fourth value.

5. The method of claim 4, further comprising, when a boundary between the blocks is a macroblock boundary, setting the deblocking filter strength to a fifth value greater than the fourth value to apply stronger filtering to the blocks.

6. The method of claim 4, further comprising, setting the deblocking filter strength based on an identified dependency between the blocks.

7. The method of claim 5, further comprising, when the boundary between the blocks is not the macroblock boundary, setting the deblocking filter strength to a sixth value greater than the fourth value and less than the fifth value.

8. The method of claim 7, wherein the first value is 0, the second value and the third value are both 1, the fourth value is 2, the fifth value is 4, the sixth value is 3, and the threshold is 4.

9. The method of claim 1, further comprising, when the blocks have a different number of reference pictures, setting the deblocking filter strength of the blocks to the first value.

10. The method of claim 1, further comprising, comparing a plurality of weighted prediction parameters from at least two blocks.

11. The method of claim 1, further comprising, when both the compared weighted prediction parameter and an additional predetermined parameter in the blocks are different, setting a deblocking filter strength of the blocks to a fourth value;

12. A method for configuring a deblocking filter to reduce banding artifacts comprising:
comparing an illumination compensation parameter of a video codec inter-prediction process in a plurality of blocks of image data using a processing device;
when the illumination compensation parameter is similar in the plurality of blocks, setting a deblocking filter strength to a first value; and
when the illumination compensation parameter is different in the plurality of blocks, setting the deblocking filter strength to a second value.

13. The method of claim 12, wherein the illumination compensation parameter is a scaling parameter applied to a motion compensated signal for a motion vector.

14. The method of claim 12, wherein the illumination compensation parameter is an offset applied to a scaled motion compensation signal for a motion vector.

15. The method of claim 12, wherein the first value is less than the second value, the first value indicating that filtering should be skipped for the blocks, and the second value indicating that filtering should be applied to the blocks.

16. The method of claim 15, further comprising:
comparing a plurality of illumination compensation parameters in the plurality of blocks including (i) a scaling parameter applied to a motion compensated signal for a motion vector, and (ii) an offset applied to a scaled motion compensation signal for a motion vector;
setting the deblocking filter strength to the first value when the scaling parameter and the offset are similar in the blocks; and
setting the deblocking filter strength to the second value when at least one of the scaling parameter and the offset are different in the blocks.

17. The method of claim 16, further comprising:
calculating a difference between motion vectors of the respective blocks in a horizontal direction and a vertical direction;
setting the deblocking filter strength to a third value higher than the second value when both (i) the difference in at least one of the directions is greater than or equal to a threshold and (ii) the at least one of the scaling parameter and the offset are different in the blocks;
setting the deblocking filter strength to the second value when only one following condition applies: (i) the difference in at least one of the directions is greater than or equal to a threshold, or (ii) the at least one of the scaling parameter and the offset are different in the blocks; setting the deblocking filter strength of the blocks to the second value; and
setting the deblocking filter strength to the first value when (i) the difference in both directions is less than the threshold and (ii) the scaling parameter and the offset are similar in the blocks.

18. The method of claim 16, further comprising:
calculating a difference between motion vectors of the respective blocks in a horizontal direction and a vertical direction;
when the difference in at least one of the directions is greater than or equal to a threshold, setting the deblocking filter strength of the blocks to the second value; and
when the difference in both directions is less than the threshold, setting the deblocking filter strength of the blocks to the first value.

19. The method of claim 18, further comprising, when the blocks have different reference pictures or a different number of reference pictures, setting the deblocking filter strength to the second value.

20. The method of claim 19, further comprising, when at least one of the blocks has non-zero discrete cosine coefficients, setting the deblocking filter strength to a third value greater than the second value.

21. The method of claim 20, further comprising, when at least one sample of the blocks is intra-coded, setting the deblocking filter strength to a value greater than or equal to the third value.

22. The method of claim 21, further comprising, when at least one sample of the blocks is intra-coded and a boundary between the blocks is a macroblock boundary, setting the deblocking filter strength to a fourth value greater than the third value.

23. The method of claim 22, further comprising, when at least one sample of the blocks is intra-coded and the boundary between the blocks is not the macroblock boundary, setting the deblocking filter strength to the third value.

24. The method of claim 23, further comprising, when at least one sample of the blocks is intra-coded and the boundary between the blocks is not the macroblock boundary, setting the deblocking filter strength to a fifth value greater than the third value and less than the fourth value.

25. An image processor comprising:
a buffer;
a processing device;
a prediction unit for estimating, using the processing device, image motion between a source image being coded and a reference frame stored in the buffer and generating a weighted motion prediction parameter stored in a reference index for each of a plurality of blocks of image data; and
a filter system for:
comparing the weighted prediction parameter of different blocks of the image data;
when the compared weighted prediction parameter in the blocks is different, setting a deblocking filter strength of the blocks to a first value;
when the weighted prediction parameter in the blocks is similar:
calculating a difference between motion vectors of the respective blocks in a horizontal direction and a vertical direction;
when the difference in at least one of the directions is greater than or equal to a threshold, setting the deblocking filter strength of the blocks to a second value; and
when the difference in both directions is less than the threshold, setting the deblocking filter strength of the blocks to a third value.

26. The image processor of claim 25, wherein the filter system includes:
a strength derivation unit for comparing the weighted prediction parameter of different blocks and setting the deblocking filter strength for each of the compared blocks; and
a deblocking filter for applying deblocking filtering to image data at a strength provided by the strength derivation unit.

27. The image processor of claim 25, wherein the prediction unit includes:
a motion estimator for estimating the image motion between the source image being coded and the reference frame; and
a mode decision unit for assigning a prediction mode to code the blocks of image data and select a coded block from the buffer to serve as a prediction reference for the image data to be coded.

28. The image processor of claim 27, wherein the mode decision unit selects a prediction mode to be used and generates motion vectors corresponding to the selected prediction mode.

29. The image processor of claim 28, wherein the prediction mode is uni-predictive or bi-predictive.

30. An image processor comprising:
a buffer;
a processing device;
a prediction unit for estimating, using the processing device, image motion between a source image being coded and a reference frame stored in the buffer and generating a illumination compensation parameter associated with respective blocks of image data; and
a filter system for:
comparing the illumination compensation parameter of a video codec inter-prediction process in the respective blocks of image data;
when the illumination compensation parameter is similar in the plurality of blocks, setting a deblocking filter strength to a first value; and
when the illumination compensation parameter is different in the plurality of blocks, setting the deblocking filter strength to a second value.

31. The image processor of claim 30, wherein the filter system includes:
a strength derivation unit for comparing the illumination compensation parameter of different blocks and setting the deblocking filter strength for each of the compared blocks; and
a deblocking filter for applying deblocking filtering to image data at a strength provided by the strength derivation unit.

32. The image processor of claim 30, wherein the prediction unit includes:
a motion estimator for estimating the image motion between the source image being coded and the reference frame; and
a mode decision unit for assigning a prediction mode to code the blocks of image data and select a coded block from the buffer to serve as a prediction reference for the image data to be coded.
